(19) United States
(12) Patent Application Publication
(10) Pub. No.: US 2019/0140819 A1
(43) Pub. Date: May 9, 2019

(54) SYSTEM AND METHOD FOR MEKLE PUZZLES SYMETERIC KEY ESTABLISHMENT AND GENERATION OF LAMPORT MERKLE SIGNATURES

(71) Applicant: SECRET DOUBLE OCTOPUS LTD, Tel-Aviv (IL)

(72) Inventor: Shlomi DOLEV, Omer (IL)

(73) Assignee: SECRET DOUBLE OCTOPUS LTD, Tel-Aviv (IL)

(21) Appl. No.: 15/806,429

(22) Filed: Nov. 8, 2017

(51) Int. Cl. H04L 9/06; H04L 9/32; H04L 29/06

(52) U.S. Cl. CPC H04L 9/06; H04L 9/3263; H04L 63/061; H04L 9/3247; H04L 9/3242; H04L 63/0442

(57) ABSTRACT

A system and method for signing a message and establishing a symmetric key between two entities. A plurality of leaves are generated, each including public and private values of a Lamport signature; a plurality of trees are generated each including a subgroup of leaves; leaves of a first nested tree are used for signing messages sent to a second entity. If a first nested tree is exhausted, then a leaf of a following tree is used for signing and a root of the following tree together with an auxiliary value are published, the auxiliary value enabling the second entity to verify that the root of the following tree was generated by the first entity. The symmetric key is generated using a modified Merkel puzzle including a plurality of rows, each including a plurality of hashed values. The modified Merkel puzzle may be signed using a leave of a nested tree.

### FIELD OF THE INVENTION

Embodiments of the present invention relate generally to security and authentication. More specifically, embodiments of the present invention relate to encoding signatures and encrypting communication channels.

### BACKGROUND OF THE INVENTION

Common practice for signing electronic or computer-implemented transactions/messages by a signing entity for the sake of non-repudiation and proof of approval of transaction is based on a pair of a public key and a fitting or matching private key. It is the responsibility of a certificate authority to identify the signing entity and to keep the private key secret and unrevealed, as the ownership of the private key is associated with approval of transactions made by the signing entity.

While commonly integer factorization is used as the base for public-private key systems, they are not quantum safe, as Shor's algorithm can be used to break such public keys, revealing the private key. Post quantum crypto systems based on cryptographic hash functions can serve as a base for digital. signatures, for example, by the use of the Lamport and/or the Merkle signature schemes.

According to Lamport one-time signature scheme, a signing entity may generate n pairs of random numbers that may form a private key. The signing entity may then generate a fitting or corresponding public key by hashing each number of the n pairs. The public key may be published.

The signature may be calculated using the original message, a hashed message or encrypted message. To sign a message, one random number out of a corresponding pair of random numbers may be selected for each bit of the message (or the hashed/encrypted message) according to the value of the bit. Thus, if the value of the bit is ‘0’, a first number of the corresponding pair of random numbers may be chosen, and in the value of the bit is ‘1’ a second number of the pair may be chosen. The string of selected random numbers forms the signature.

When a verifying entity receives the message and wishes to verify the signature, the verifying entity may pick out or select hash values from the public key, in the same manner as the signing authority did, e.g., pick a first value of a pair of hashed values if the value of the bit is ‘0’ and a second value if the value of the bit is ‘1’, thus obtaining a “first hashed signature”. The verifying entity may then hash the values in the signature received from the signing entity, thus obtaining a “second hashed signature”. The signature is verified if the “first hashed signature” exactly matches the “second hashed signature”. Otherwise, the signature is wrong.

As Lamport signature scheme is one time, Merkle trees, also referred to as hash trees, are used to encode potential signatures in each leaf of the Merkle tree. Values in the root of the tree may serve, possibly, together with the tree height value, as the public key and may be accessible to the verifier entity. Height value may be redundant if two globally agreed upon hash functions are used, one for computing the hash in the leaves and the other for the rest of the tree nodes. Communicating the value associated with the root is a delicate process that requires the identification of the owner of the public key, just as certificate authorities do. The use of Lamport signatures with Merkle trees implies less frequent need for repeating such identification, giving longer period to renew the identification with the next Merkle tree of Lamport signatures.

Merkel puzzles enable two entities to establish a secret by exchanging messages. Merkel. puzzles do not rely on number theory based schemes and do not require sharing common secretes beforehand. A first entity generates a large number of messages, each containing an identifier and a symmetric key. The first entity encrypts the messages such that a second entity may decrypt a message using brute force analysis, and sends the encrypted messages to the second entity. The second entity solves one of the encrypted messages using brute force analysis, discovers the identifier and the symmetric key of that one message. The second entity sends the identifier to the first entity who can thus identify the symmetric key. The first and second entities may use the symmetric key for encrypting messages. An eavesdropper, who wishes to get hold of the symmetric key, has to solve all the encrypted messages (or at least half of the encrypted messages on the average) to get the symmetric key.

### SUMMARY OF THE INVENTION

According to embodiments of the invention there is provided a systemand method for signing a message by a first entity. Embodiments of the invention may include: generating a plurality of leaves, wherein each leaf is a data structure which may include public values corresponding to private values of a one-time Lamport signature; generating a plurality of trees each including a subgroup of the plurality of leaves; using leaves of a currently used tree for signing messages sent to a second entity; and if a last leaf of the currently used tree was used for signing, then using a leaf of a following tree for signing a message.

According to embodiments of the invention, the private values may include a hash-based pseudo-random sequence. The hash-based pseudo-random sequence may be generated by hashing two values and performing an operation between hash results. The operation may be bitwise XOR.

Embodiments may include that if the last leaf of the currently used tree was used for signing, a root of a following tree is published, or a root of the following tree and an additional or auxiliary value is published, the auxiliary value enabling the second entity to verify that the root of the following tree was generated by the first entity. The auxiliary value may provide an expected result when applying an operation on the auxiliary value and the root of the following tree. The auxiliary value may be generated so that hashing a concatenation of the root of the following tree and the auxiliary value provides the auxiliary value of the currently used tree.

According to embodiments of the invention, the trees may be nested trees and private values of a nested tree of level k are generated by hashing private values of a nested tree of level k−1 using a cryptographic hash function. Private values of a nested tree of a first level may be generated by hashing one or two values.

According to embodiments of the invention there is provided a system and method for establishing a symmetric key between two entities. The method may include for example generating a modified Merkel puzzle, wherein the modified Merkel puzzle may include a plurality of rows, each row including a plurality of hashed values, each preimage of a hashed value including a row serial number and a random string; sending the hash based Merkel puzzle to a second entity; receiving an ill identifier from the second entity, wherein the identifier is generated by the second entity by: selecting a row; finding the preimage of the messages of the selected row; and extracting the identifier of the selected row from at least two preimages; selecting a same row as the second entity according to the received identifier; extracting a symmetric key from the selected row; and using the symmetric key to encrypt communication with the second entity.

Embodiments of the invention may include performing a plurality of iterations of generating symmetric keys, wherein in each iteration new modified Merkel puzzles may be generated. Embodiments of the invention may include encoding the modified Merkel puzzles using a symmetric key from a previous iteration prior to sending.

Embodiments of the invention may include signing the encoded modified Merkel puzzles, e.g., using a leaf of the currently used tree; and sending the signature together with the encoded modified Merkel puzzles to the second entity.

Some embodiments of the invention may include extracting the symmetric key by performing an operation on a subset of strings of the selected row.

### BRIEF DESCRIPTION OF THE DRAWINGS

Non-limiting examples of some embodiments of the invention are described below with reference to figures attached hereto that are listed following this paragraph. Identical features that appear in more than one figure are generally labeled with a same label in all the figures in which they appear. A label labeling an icon representing a given feature of an embodiment of the invention in a figure may be used to reference the given feature. Dimensions of features shown in the figures are chosen for convenience and clarity of presentation and are not necessarily shown to scale.

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Some embodiments of the invention are illustrated by way of example and not limitation in the figures of the accompanying drawings, in which like reference numerals indicate corresponding, analogous or similar elements, and in which:

FIG. 1 is a schematic illustration of an exemplary system, according to embodiments of the invention;

FIG. 2A depicts a Merkel tree which forms the base for all other root nested trees, according to embodiments of the invention;

FIG. 2B depicts a first nested tree, according to embodiments of the invention;

FIG. 2C depicts a k^{th} nested tree, according to embodiments of the invention;

FIG. 3A is a flowchart of a method for using a plurality trees for signing messages, according to embodiments of the invention;

FIG. 3B which is a flowchart of a method for using a plurality of trees for signing messages, according to embodiments of the invention;

FIG. 4 is a flowchart of a method for using nested trees for signing messages, according to embodiments of the invention;

FIG. 5 depicts a modified Merkel puzzle, according to embodiments of the invention;

FIG. 6 is a flowchart of a method for establishing a symmetric key between two entities, according to embodiments of the invention; and

FIG. 7 is schematic illustration of an exemplary device according to embodiments of the invention.

It will be appreciated that, for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although some embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although some embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

Embodiments of the present invention relate to encoding signatures and encrypting communication channels. Combined with quantum safe certificate authority and symmetric key establishment all based on cryptographic hash, rather than unproven number theory based schemes, and/or information theoretic secure schemes, e.g., one-time pad, secret sharing, to integrate and then replace the Internet security to be quantum safe. In particular, efficient practical nested hashed Lamport signatures coupled with nested (hashed) Merkle trees and hash based Merkle puzzles. The height of the Merkle tree, ranges from zero to any integer, may be tuned to address the tradeoff between communication, when communicating the path or route to the root as part of the signature, and the number of signatures between two consecutive identifications of the signing entity by the certificate authority. Compared with prior art use of Merkle trees, embodiments of the invention provide a method and system using trees with reduced height for the same number of leaves. Thus, in some embodiments the values that need to be sent or communicated as the path or route to the root may be significantly reduced. Similarly, the number of nesting hashes used can be tuned up to address memory efficiency versus the need to compute number of hashes. For example, embodiments of the invention may enable storing a single or a small number of “seeds” and generating leaves cryptographically hashing these seeds. The combination of cryptographic hash, blockchain based certificate authorities with a plurality of certificate authorities, complete the creation of hash based, quantum safe public key infrastructure, resulting in an efficient complete quantum safe security suit for the Internet. In some embodiments signature roots of the certificate authorities are widely known publicly so that the certificate authorities may transitively sign signature tree root of other entities.

According to embodiments of the present invention, Merkle trees of Lamport signatures may be nested using a cryptographic hash functions. As used herein, cryptographic hash functions may refer to one-way functions that map data of arbitrary size to a bit string of a fixed size. It may be computationally infeasible to invert cryptographic hash functions, e.g., after applying a cryptographic hash function on an original value (e.g., a preimage), it may be computationally infeasible to calculate the original value or the preirnage from the hashed value. Embodiments of the present invention may use a plurality of different cryptographic hash functions, for example a family of Secure Hash Algorithm 3 (SHA-3) hash functions parameterized by values of random keys, for example, as in message authenticating code (MAC).

Embodiments of the present invention may provide a system and method of signing a message sent between two entities by generating a plurality of root-nested trees. Root-nested trees may refer to a plurality of trees, each having a root independent from, or not correlated with, roots of the other trees. Root nesting may be achieved by encoding the plurality of tree roots in a nested manner, and providing a root of a first tree and a hash based nested root values for all other trees. The root of a first tree and the hash based nested root values may be provided to a certificate authority when the signing entity is identified by the certificate authority. Thus, allowing a practically unbounded period for authenticating the entity without the need to re-identify and re-couple the entity identity with the public key (e.g., tree roots) or to store upfront all the root values, which in turn can be stolen.

Some embodiments of the invention allow the use of succinct representation of the tree leaves (a computer manipulated data structure), rather than storing them all in memory, where hash-based pseudo-random sequences define the value of each value in each leaf, implying smaller memory requirement for the leaves values that represent the private keys.

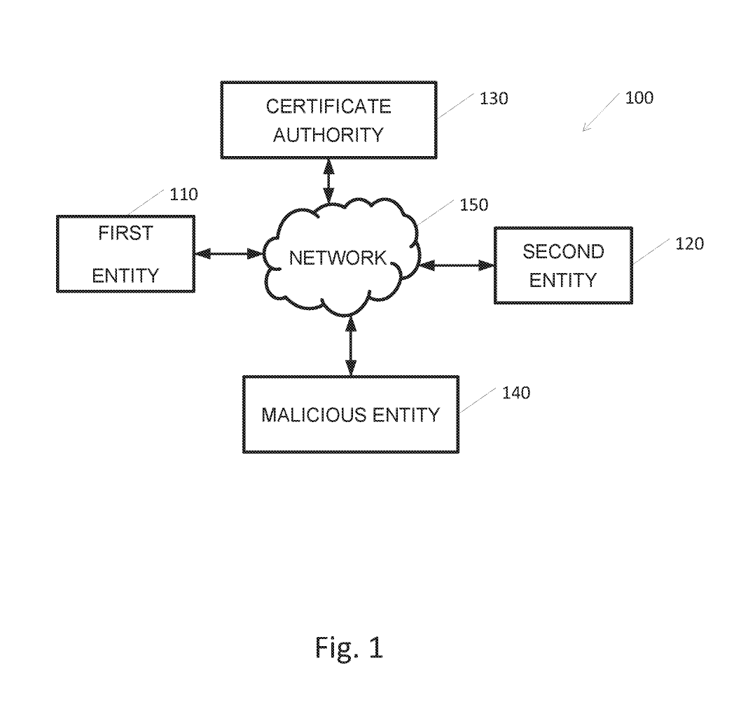

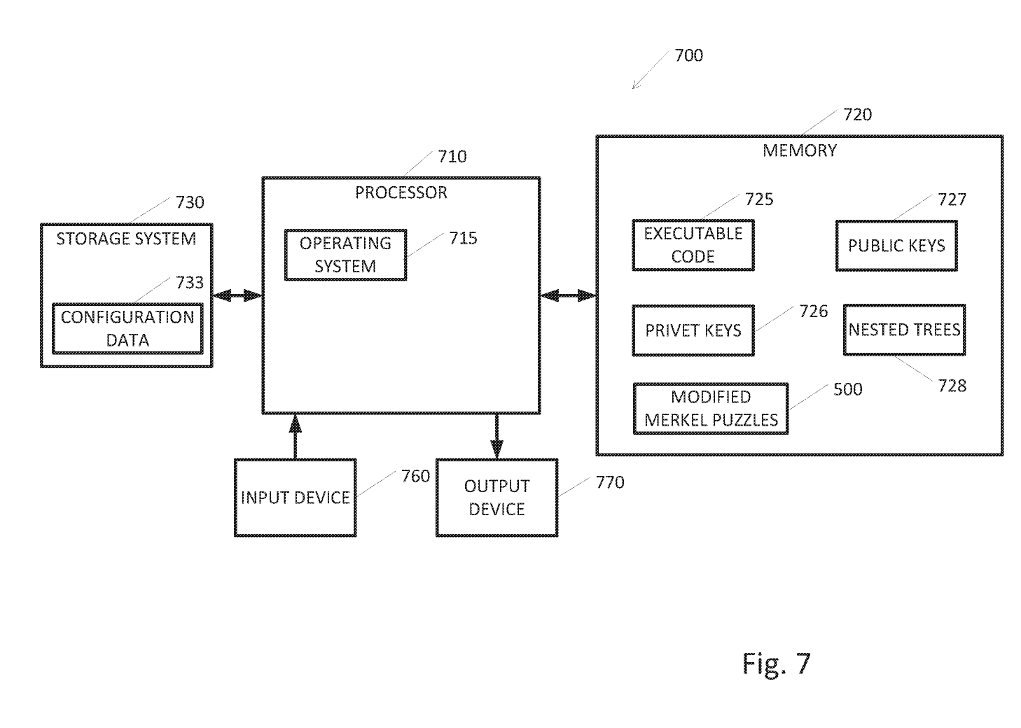

Reference is made to FIG. 1, which is a diagram of an exemplary system 100 according to some embodiments of the present invention. As shown, system 100 may include a first entity 110, also referred to as signing entity 110, a second entity 120 also referred to as verifying entity 120, and a certificate authority 130. As known, system 100 may include an unwanted malicious entity 140. Each of first entity 110, second entity 120, certificate authority 130 and malicious entity 140 may be or may include a computing device, for example, a computing device 700 depicted in FIG. 7 or another suitable device.

Network 150 may be, may include or may be part of a private or public IP network, or the internet, or a combination thereof. Additionally or alternatively, network 150 may be, comprise or be part of a global system for mobile communications (GSM) network. For example, network 150 may include or comprise an IP network such as the internet, a GSM related network and any equipment for bridging or otherwise connecting such networks as known in the art. In addition, network 150 may be, may comprise or be part of an integrated services digital network (ISDN), a public switched telephone network (PSTN), a public or private data network, a local area network (LAN), a metropolitan area network (MAN), a wide area network (WAN), a wireline or wireless network, a local, regional, or global communication network, a satellite communication network, a cellular communication network, any combination of the preceding and/or any other suitable communication means. Accordingly, numerous elements of network 150 are implied but not shown, e.g., access points, base stations, communication satellites, GPS satellites, routers, telephone switches, etc. It will be recognized that embodiments of the invention are not limited by the nature of network 150.

According to some embodiments of the invention, certificate authority 130 may be a centralized entity. According to some embodiments of the invention, certificate authority 130 may include a plurality of decentralized and distributed entities, e.g., certificate authority 130 may be implemented as a or as part of a distributed blockchain.

According to some embodiments of the invention, signing entity 110 and verifying entity 120 may be involved in sending and receiving messages, for example as part of a transaction or a purchase, or any other activity, in verifying second entity 120 would like to have a signature of signing entity 110 for non-repudiation and proof of approval. According to embodiments of the present invention, signing entity 110 may provide or send a signature based on nested Merkle trees of Lamport signatures, also referred to as root nested trees, or nested trees, as disclosed herein. According to some embodiments, certificate authority 130 may sign messages sent by signing entity 110, e.g., signing entity 110 may send messages to verifying entity 120, and certificate authority 130 may sign these messages. Thus, it is noted that certificate authority 130 may, in some embodiments, operate as the signing entity.

According to some embodiments of the invention, using root-nested trees adds another dimension to the Merkel trees and increases the number of possible Lamport signatures. Specifically, each level of nesting doubles the number of possible Lamport signatures. Nesting may be performed by applying cryptographic hash function to the values of the roots together with auxiliary values and/or to the leaves of the original Merkle trees of Lamport signatures, as disclosed herein.

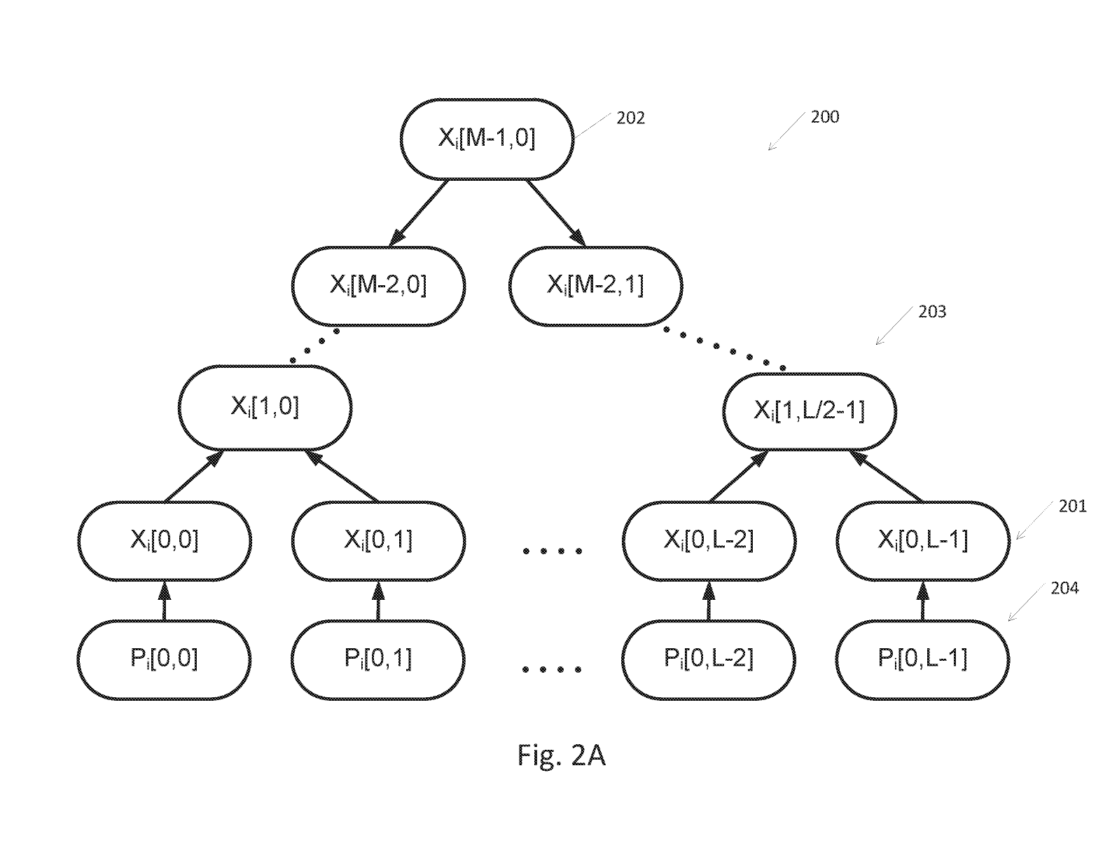

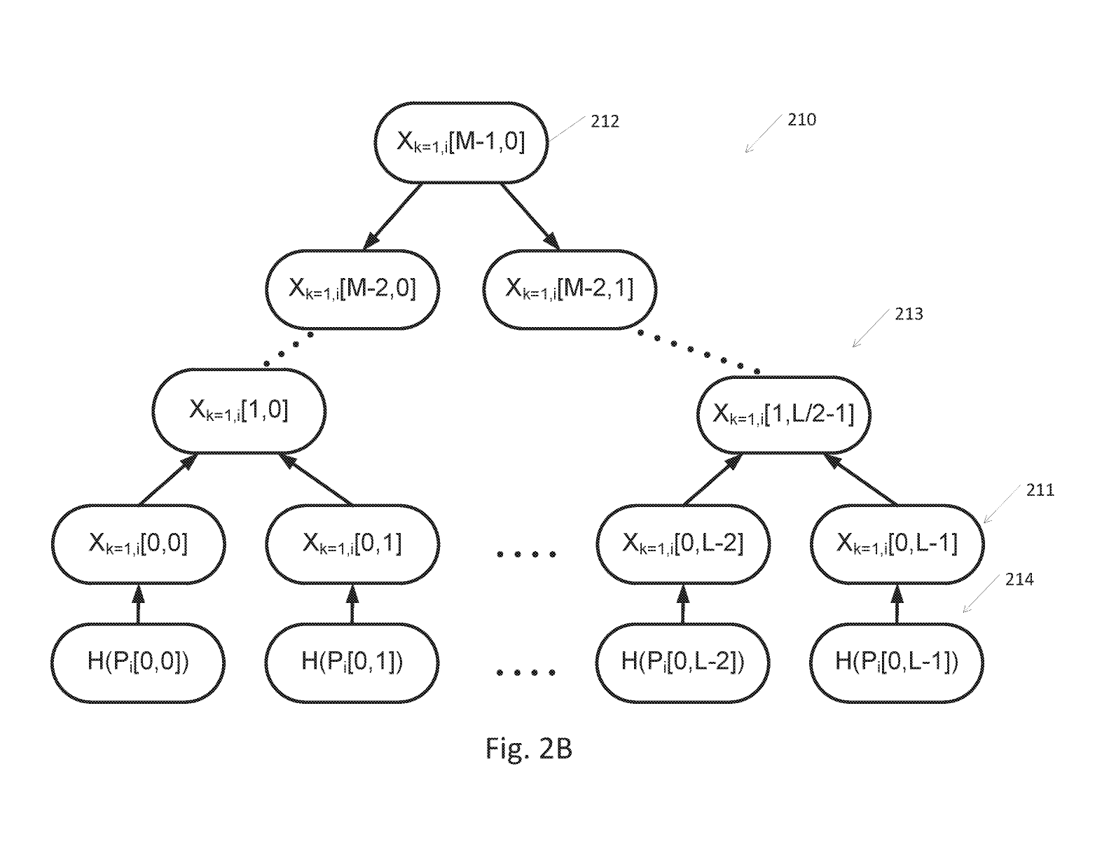

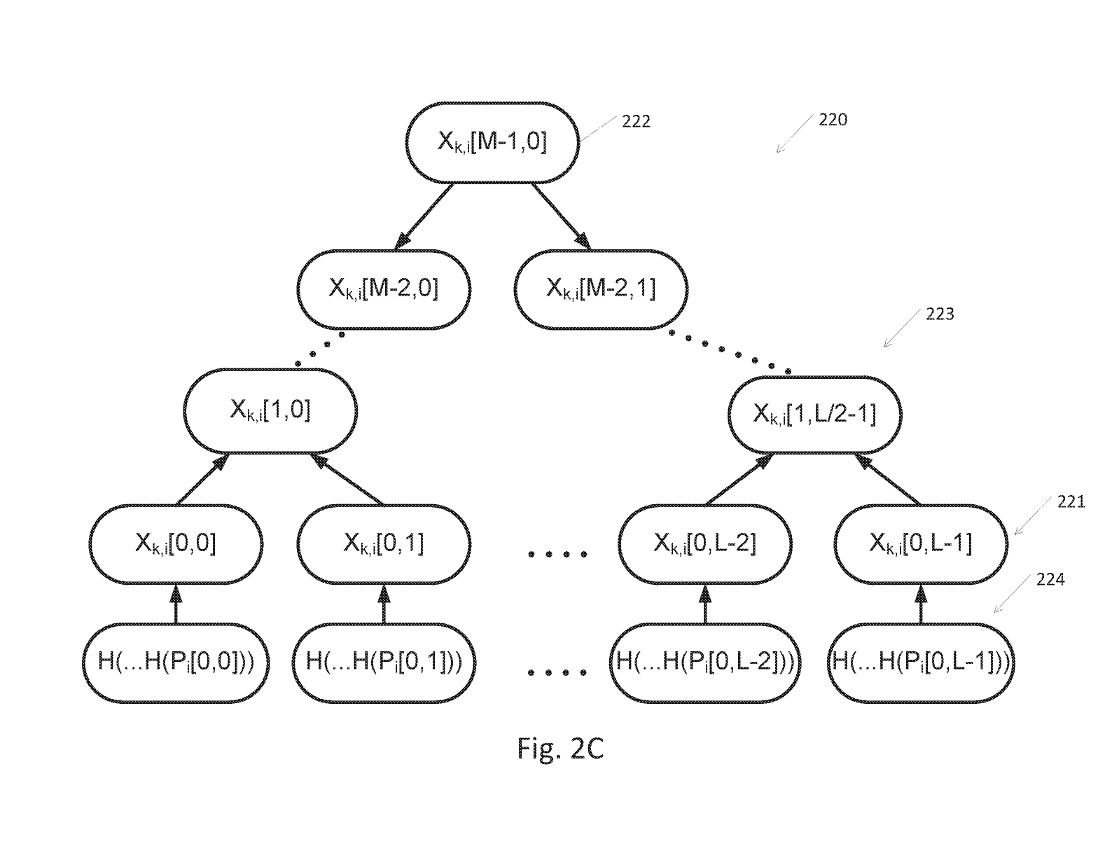

Reference is now made to FIGS. 2A-2C, depicting an example of nested trees according to some embodiments of the invention. FIG. 2A depicts a Merkel tree 200 which forms the base for all other nested trees and is the last tree to be used for signing, according to some embodiments of the invention. Merkel tree 200, also referred to herein as nested tree of first level or original tree 200, may include leaf nodes 201, intermediate nodes 203 and root node 202. Let L be the number of leaves, l be the left-right index, M be the tree height and m the height index, m=0, 1, 2 . . . M−1, where m=0 indicates a leaf node 201 and in m=M−1 indicates the root node 202, and i be the bit index i=0, 1, . . . , n−1. Let=Xi[m,l]=[X_0i[m, l] X_1i[m, l]] denote a node value for bit i, where X_0i[m, l] is the value associated with a logical zero in bit i, and X_1i[m, l] is the value associated with a logical one in bit i, in a tree at level in and left-right position l. For example, Xᵢ[0,0] may denote the leftmost leaf value associated with bit i, Xᵢ[1,L−1] may denote the rightmost node at level one in bit i, and Xᵢ[M−1, 0] denotes the root value in bit i. Each leaf 201 in the Merkel-tree may be a source of a single one-time (e.g., suitable for a single use) Lamport signature. Thus, each leaf 201 may include public values Xᵢ[0,1] of a single Lamport signature, where Xi[0, 1]=H(Pi[0, 1])=[H(P_0i[0, 1]) H(P_1i[0, 1])] and. Pᵢ[0,1] are private values 204 for bit i, where P_0i[0,1] is a private value for logical zero in bit i, and P_1i[0,1] is a private value for logical one in bit i of a single signature l. Each node 203 at a higher level, m, may have two child nodes at level m−1, and may be calculated by hashing a concatenation of its two child nodes (or public values of leaves 201). For example:

Xi[1,0]=H(Xi[0,0]Xi[0,1]) (equation 1)

Or in a more general form:

Xi[m, l]=H(Xi[m−1,2l]∥Xi[m−1,2l+1]) (equation 2)

Where if denotes a cryptographic hash operation, and ∥ denotes a concatenation operation that joins the value to the right with the value to the left (for example concatenating the strings ‘00’ and ‘11’ would result in ‘0011’: ‘00’∥‘11’=‘0011’).

To generate a signature, signing entity 110 may select a single leaf 201 that has not been previously used, sign according to one-time Lamport signature scheme and add additional information to unambiguously prove that the signature originated form his tree, and not generated by another, e.g, by malicious entity 140. The additional information may include sufficient information that may enable verifying entity 120 to unambiguously generate or calculate the root value. For example, the additional information may include a subset of intermediate nodes that may form a path or route to the root and the direct child nodes of the subset of intermediate nodes. In order to verify the signature, verifying entity 120 may verify the one-time Lamport signature and in addition, verifying entity 120 may generate the root value and compare it to the public root value. If the one-time signature is valid and the generated root value is identical to the public root value, then the signature is valid.

According to some embodiments, leaves 201 of Merkel tree 200 may be ordered by a sequence number that may be updated each time a leaf 201 is used. The current sequence number may be published, e.g, sent or otherwise made available to any entity who desires access to this information, for example by posting on a website, for example, through certificate authority 130, to verifying entity 120. According to some embodiments, leaves 201 of Merkel tree 200 may be associated with a globally synchronized time stamp, so that a single leaf 201 may be used only during a predefined time period.

FIG. 2B depicts a first nested tree 210 according to embodiments of the invention. First nested tree 210 may include leaf noes 211, intermediate nodes 213 and root node 212. The new private values 214 of nested tree 210 may be generated by hashing the private values 204 of the original Merkel tree 200 using a cryptographic hash function. Public values in leaves 211 for the new private values 214 and the entire nested tree 210 may be generated using a hash functions as disclosed herein with reference to the Merkel tree 200 of FIG. 2A. For example the following example equations may be used:

X_{k=1,i}[0,1]=H(H(Pᵢ[0,1])) (equation 3)

and

X_{k=1,i}[m,l]=H(X_{k=1,i}[m−1,2l]∥X_{k=1,i}[m−1,2l+1]) (equation 4)

FIG. 2C depicts a k^{th} nested tree 220 according to embodiments of the invention. Let k denote the level of nesting, from a total of K nested trees, k=0, 1, . . . , K−1, where k=0 denotes the original Merkel tree 200 and k=K−1 denotes the last tree (and the first tree to be used). Private values 224 of nested tree 220 of level k may be generated by hashing the private values of the nested tree of level k−1 using a cryptographic hash function, k^{th} nested tree 210 may be generated by hashing the private values 214 of the k−1^{th} nested tree using a cryptographic hash function. Public values in leaves 221 for the new private 224 values and the entire k^{th} nested tree 210 may be generated using a hash functions as disclosed herein with reference to the Merkel tree 200 of FIG. 2A. For example the following example equations may be used:

X_{k=1,i}[0,1]=H( . . . H(Pᵢ[0,1]))), (equation 6)

and

X_{k,i}[m,l]=H(X_{k,i}[m−1,2l]∥X_{k,i}[m−1,2l+1]) (equation 7)

According to some embodiments of the invention a plurality of cryptographic hash functions may be used. For example, one cryptographic hash function may be used for hashing the private values 204, 214, 224 of each nested Merkel tree 200, 210, 220 to get the public values and build the nested Merkel tree 200, 210, 220, and another cryptographic hash function may be used for hashing the private values 204, 214, 224 to generate leaves 201, 211, 221 of nested trees 200, 210, 220, k^{th} nested tree 210 may include leaf noes 221, intermediate nodes 223 and root node 222.

According to embodiments of the present invention, the first tree to be used is the last nested tree, e.g., the K−1^{th} nested tree. When the nested tree is exhausted, e.g., when all of the leaves 221 of a tree 220 were used, the K−2^{th} nested tree may be used and so forth. Thus, nesting trees may add another dimension to the Merkel trees and may enable generating many more signatures. The public key for each nested tree 200, 210, 220 may be the root 202, 212, 222 of that tree. The verifying entity should know the value of the current root, e.g., a root of a tree that is used for signing at least a next message, which is the public key for the tree currently in use. When a k^{th} nested tree 220 is exhausted, a new root should be published for the k−1 nested tree, and verifying entity 120 or certificate authority 130 should be able to verify that the new root was generated by signing entity 110 and not by a forger, e.g., malicious entity 140. According to some embodiments, root nesting may be performed to enable verifying that the new root was generated by signing entity 110. Root nesting may include publishing, by signing entity 110 in addition to the new root, rootₖ₋₁, an additional number or an additional or auxiliary value, Vₖ₋₁, that may enable verifying entity 120 or certificate authority 130 to verify that the new root was generated by signing entity 110. For example, the auxiliary value may provide or result in an expected result when applying an operation on or performing a calculation using the auxiliary value and the new root. In some embodiments, the auxiliary values may be generated so that hashing a concatenation of the new root value and the auxiliary value may provide or result in the auxiliary value of the previous tree. For example, the following may hold true:

Vₖ=H(rootₖ₋₁∥Vₖ₋₁) (equation 8)

Thus, verifying entity 120 or certificate authority 130 may perform the above operation on the new root and the auxiliary value and may verify that the result equals the auxiliary value from the previous iteration. If the equation holds true, verifying entity 120 or certificate authority 130 may conclude that the new root was generated by signing entity 110. Otherwise, verifying entity 120 and certificate authority 130 may suspect that that the new root was not generated by signing entity 110.

To generate a signature from nested trees 220, signing entity 110 may select a single leaf 201, 211, 221 that has not been previously used from a tree 200, 210, 220 currently in use, sign according to one-time Lamport signature scheme and add additional information to unambiguously prove that the signature originated form a tree 200, 210, 220 of signing entity 110, and not generated by another. The additional information may include sufficient information that may enable verifying entity 120 to unambiguously generate or calculate the root value. For example, the additional information may include a subset of intermediate nodes 203, 213, 223 that may form a path to the root 202, 212, 222 and direct child nodes of the intermediate nodes 203, 213, 223. When using a leaf 201, 211, 221 of a new tree (after a previous tree has been exhausted) signing entity 110 may add a new root and additional information that may prove that the new root was generated by signing entity 110 and not by a forger. For example, the additional information may include V_{K-1}, as disclosed herein.

In order to verify the signature, verifying entity 120 may verify the one-time Lamport signature and in addition, verifying entity' 120 may generate the root value and compare it to the public root value. If the one-time signature is valid and the generated root value is identical to the public root value, then the signature is valid. In case a new tree is used, verifying entity 120 may verify the new root as disclosed herein.

According to some embodiments of the invention, signing entity 110 may store all private values as well as values of all leaves 201, 211 and 221, intermediate nodes 203, 213 and 223 and roots 202, 212 and 222 of all nested Merkel trees 200, 210 and 220. According to some embodiments, a. leaf 201, 211, 221 that has been used may be deleted, and after a last leaf 201, 211, 221 of a nested Merkel tree 200, 210 and 220 is used, e.g., when all of the leaves such as 201, 211, 221 of respective nested Merkel trees 200, 210 and 220 are used, the tree may be considered exhausted and the entire tree may be deleted. According to some embodiments, signing entity 110 may store only the private values that form the base for all trees 200, 210 and 220, and may calculate the entire nested tree 200, 210 and 220 that is currently being used only when signing a message. According to some embodiments, signing entity 110 may store only the private values of first tree 200, and may calculate private values and leaves 211 and 221 of all other nested trees 210 and 220, and the entire nested tree 220 that is currently being used only when signing a message. Calculation of intermediate nodes 203, 213, 223 and nested trees 210, 220 may be performed using appropriate cryptographic hash functions as disclosed herein.

According to some embodiments of the invention, signing entity 110 may generate private values 204 of original tree 200, or the private values of the plurality of trees (generated in operation 320), by hashing a small number of values, e.g., one or two values. According to some embodiments, only these values may be stored, and the entire structure of nested trees may be generated from these values using the necessary hash functions when needed, e.g., when signing entity 110 needs to sign a message. According to some embodiments of the invention, signing entity 110 may generate the private values of the plurality of trees, or private values 204 of original tree 200, based on two values, denoted RI, and RR. In some embodiments signing entity 110 may store only RL and RR and generate private values 204 of original tree 200, as well as all other nested trees 210, 220, when signing a message. In some embodiments signing entity 110 may store only RL and RR and generate the plurality of leaves in operation 320, as well as the plurality of trees in operation 325, when signing a message. In some embodiments, private values may be generated from RE and RR using cryptographic hash operations. For example, two series of numbers may be generated by hashing RL and RR using for example:

RL₁=H(RL₂=H(RL₁), RL₃=H(RL₂) . . . RLⱼ=H(RLⱼ₋₁) (equation 9)

RR₁=H(RR), RR₂=H(RR₁), RR₃=H(RR₂) . . . RRⱼ=H(RRⱼ₋₁) (equation 10)

In some embodiments, the two series of numbers may be generated frog a single value, e.g., RL, using two different hash functions H₁ and H₂ such as:

RL₁=H₁(RL), RL₂=H₁(RL₁), RL₃=H₁(RL₂) . . . RLⱼ=H(RLⱼ₋₁) (equation 11)

RR₁=H₂(RL), RR₂=H₂(RR₁), RR₃=H₂(RR₂) . . . RRj=H₂(RRⱼ₋₁) (equation 12)

In some embodiments, all private values Pᵢ[0,1], may be generated based on the two series. For example, each private value may be generated by performing a predefined operation between predefined values of the two series. For example, each private value may be generated by performing a bitwise XOR operation between respective values of the two series using for example:

P_{0i[0,1]}=RLᵢ XOR RRₙ₋ᵢ; P_1ᵢ[0,1]=RLₙ₋ᵢ XOR RRᵢ (equation 13)

using bitwise XOR for generating the leaves may disable a malicious entity from creating signature related to past trees, thus, all leaves of every tree may be XORed as disclosed herein to lock the possibility of deducing undesired versions of past used signature values.

In some embodiments of the invention, the leaves of all root-nested trees may include a single or a plurality of private secrets or values that may serve as seeds for creating pseudo-random sequence. In some embodiments, the pseudo-random sequence may be constructed from two private secrets. In some embodiments the hash-based pseudo-random sequence may be generated by sequentially hashing two values or sequentially using two hash functions over one value and performing an operation between hash results. In the following non-limiting example each leaf includes a single value, however the following method may be easily augmented to any number of values in each leaf. Let the number of leaves in each tree be l, in one embodiment of the invention the values in the i'th leaf of thefth tree may be obtained by hashing one of the private secrets, referred to herein as forward private secret, l*j+i times and the other private, secret, referred to herein as backwards private secret, n*l−(l*j+i) times, where n is the total number of trees, and then XORing (e.g., performing bitwise XOR) the two (nested hash) results. In this way, values of the cryptographic hashed based pseudo-random sequence may not reveal the values of previous and next values in the sequence. The number of pseudo random sequences, and therefore the number of private secret pairs maintained, can vary, for example, one can produce a hashed based pseudo random sequence for the i'th leaves in the trees keeping n*l*2 private secret keys, such decisions influence the needed memory for storing these private keys and the security parameter (e.g., the input size).

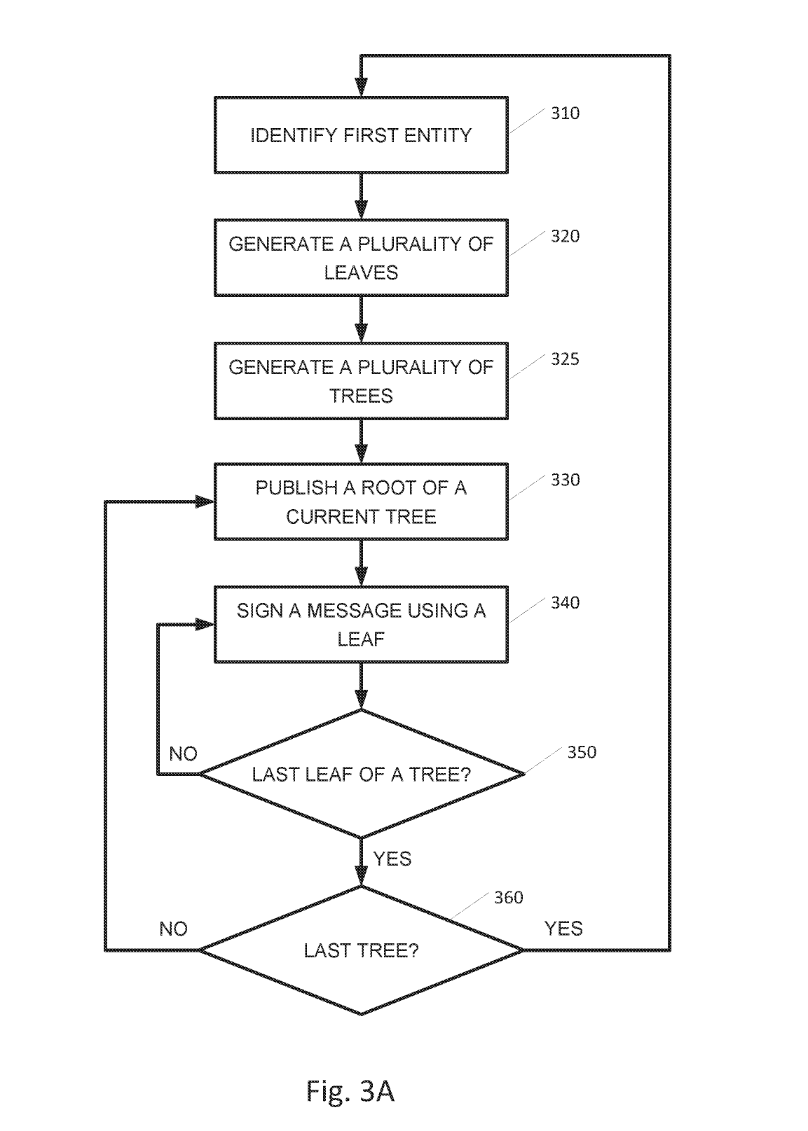

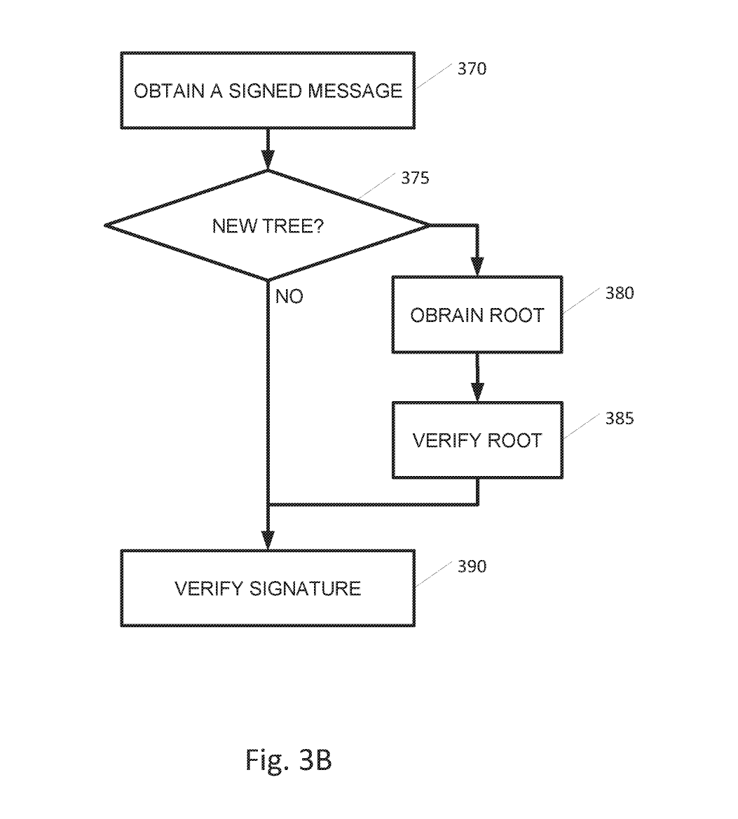

Reference is now made to FIG. 3A which is a flowchart of a method for using a plurality of trees, or root nested trees, for signing messages, according to embodiments of the invention. According to embodiments of the invention, the method for using a plurality of trees for signing messages may be performed, for example, by two entities such as first entity 110 and second entity 120, and by a certificate authority such as certificate authority 130 depicted in FIG. 1.

In operation 310, the identity of a first entity or a signing entity, such as first entity 110, may be verified or authenticated by a third party, e.g., a certificate authority such as certificate authority 130. As disclosed, the certificate authority may he centralized or distributed. In some embodiments, the certificate authority may be implemented as a, or as part of, a distributed blockchain. The signing entity may be verified according to any applicable method as a part of a registration phase, as known in the art. In operation 320, a plurality of leaves may be generated. For example, each leaf may include private values and corresponding public values of a one-time Lamport signature. Fitting or corresponding public values may be generated for example by cryptographically hashing each of the private values. The private values of the plurality of leaves may be generated according to any applicable method. In some embodiments, the private values of the plurality of leaves may be include pseudo random sequence generated as disclosed herein. According to some embodiments, the private values of the plurality of leaves may be generated by hashing a small number of values, e.g., one or two values. In some embodiments, the private values of the plurality of leaves may be generated using equations 9 and 10 or equations 11 and 12. In operation 325, a plurality of trees may be generated. For example, each tree may include a subgroup of the plurality of leaves. The trees may be generated as known in the art. For example, the trees may be generated using equation 2. In operation 330 a root of a currently used tree may be published. Similarly, when a currently used tree is exhausted, a new root should be published for a following tree, e.g., for the next tree or another tree that will be used for signing after a currently used tree is exhausted. According to some embodiments, the trees may be root-nested. Thus, when a new root is published the signing entity may also publish an auxiliary value Vₖ₋₁, that may enable the second entity to verify that the new root was generated by the signing entity, as disclosed herein. In operation 340 the signing entity may select a leaf from the current tree and use it to sign a message using a one-time Lamport signature. As indicated in the loop of operations 350 and 340, as long as there are available leaves in the tree a new leaf may be used each time the signing entity needs to sign a message. If, however, a last leaf of a currently used tree was used for signing, e.g., if a currently used tree is exhausted, then in operation 360 it may be checked whether this was the last tree. If not, a new tree may be used and the method may go back to operation 330 to publish the new root of the new tree. After the last tree is used, the first entity may have to identified again, as indicated in operation 310.

Reference is now made to FIG. 3B which is a flowchart of a method for using a plurality of trees for signing messages, according to embodiments of the invention. According to embodiments of the invention, the method for using a plurality of trees for signing messages may be performed, for example, by two entities such as first entity 110 and second entity 120, and by a certificate authority such as certificate authority 130 depicted in FIG. 1.

In operation 370 a second entity or a verifying entity, e.g., second entity 120 may obtain a signed message. If the signature pertains to an already known tree, as decided in operation 375, the second entity may verify the one-time signature, as indicated in operation 390. If, however, the signature pertains to a new tree, e.g., to a tree that is being used for the first time, the verifying entity may first obtain and verify the root of the new tree, as indicated in operations 380 and 385, and only then the second entity may verify the one-time signature in operation 390. For example, in operation 380 the second entity may obtain a new root of the new tree. According to some embodiments, in operation 380 second entity may obtain an additional number, Vₖ₋₁, from first entity and in operation 385 the second entity may verify that the new root was generated by the first entity as disclosed herein.

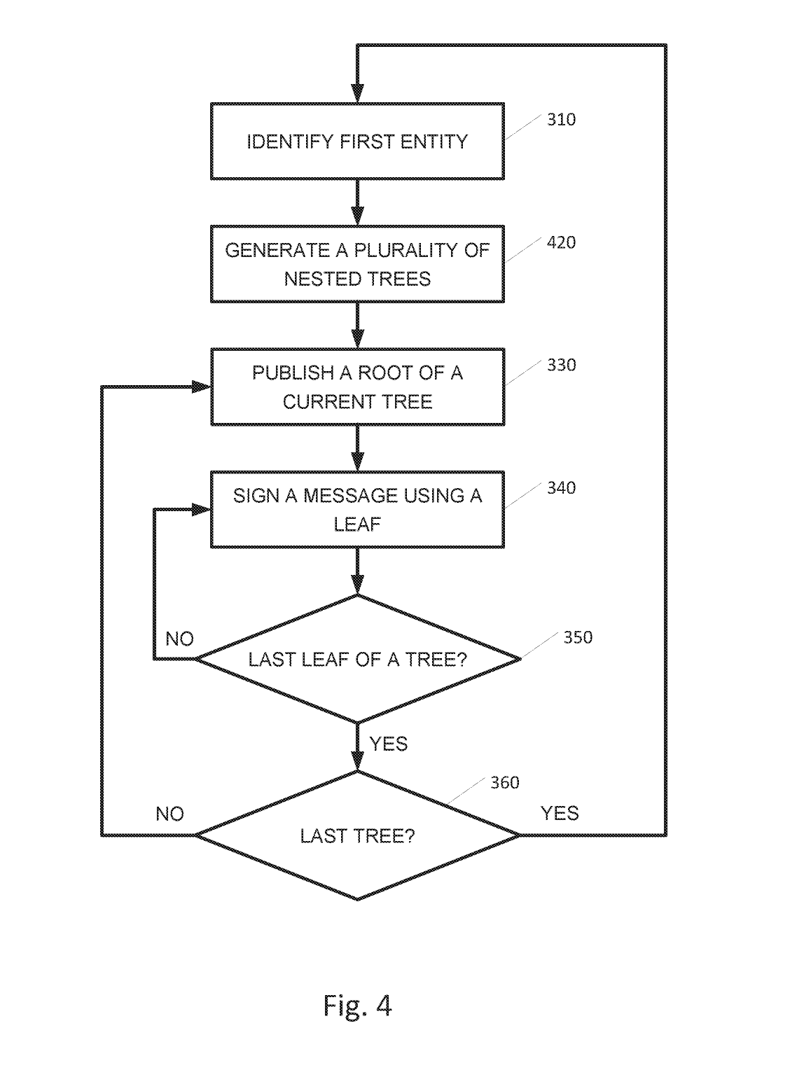

In some embodiments the plurality of trees may include nested trees, e.g., nested trees 200, 210 and 220. Reference is now made to FIG. 4 which is a flowchart of a method for using nested trees for signing messages, according to embodiments of the invention. According to embodiments of the invention, a method for using nested trees for signing messages may be performed, for example, by two entities such as first entity 110 and second entity 120, and by a certificate authority such as certificate authority 130 depicted in FIG. 1. Operations in FIG. 4 that are similar to operations in FIG. 3A have the same reference numerals and will not be described again.

In operation 420, a plurality of nested trees as disclosed herein may be generated. For example, private values of nested tree of level k may be generated by hashing private values of a k−1^{th} nested tree using a cryptographic hash function. In operation 330 a root of a current nested tree e.g., a nested tree that is currently being used for signing, may be published. Similarly, when a k^{th} nested tree is exhausted, a new root should be published for the k−1 nested tree. As indicated in the loop of operations 350 and 340, as long as there are available leaves in the tree a new leaf may be used each time the signing entity needs to sign a message. If, however, a last leaf of a nested tree was used for signing, e.g., if a currently used tree is exhausted, then in operation 360 it may be checked whether this was the last nested tree. If not, a new nested tree, e.g., a nested tree of a previous level, may be used and the method may go back to operation 330 to publish the new root of the new nested tree.

According to some embodiments, first entity 100 and second entity 200 may wish to establish a secret by exchanging messages without relying on number theory based schemes, and without sharing common secretes beforehand. According to some embodiments of the invention, first entity 100 and second entity 200 may establish a secret using composite or multi-part puzzles, also referred to herein as modified Merkel puzzles, as disclosed herein.

According to some embodiments of the present invention, there is provided a system and method of establishing a symmetric key between two entities. Some embodiments of the invention may include: generating a modified cryptographic hash based Merkel puzzle, wherein the modified Merkel puzzle may include a plurality of rows, each row comprising a plurality of hashed values, each preimage of hashed value may include a serial number of the row and a random string. The puzzles values may be encrypted using previously established symmetric keys prior to sending. The encrypted modified Merkel puzzle may be sent to a second entity. The second entity may send an identifier that may be received by the first entity, the identifier may be generated by the second entity by: selecting a row, decrypting encrypted messages of the selected row, finding the preimage of the cryptographic hash function possibly using brute force analysis of all the puzzles in the row, and extracting the identifier of the selected row from at least two preimages in the row and XORing (e.g., performing bitwise XOR) these at least two preimages to form the row identifier. After receiving the identifier, the first entity may select a row from the puzzle according to the identifier, extract the symmetric key from the selected row and use the symmetric key to encrypt communication, for example, by Advanced Encryption Standard (AES), with the other entity.

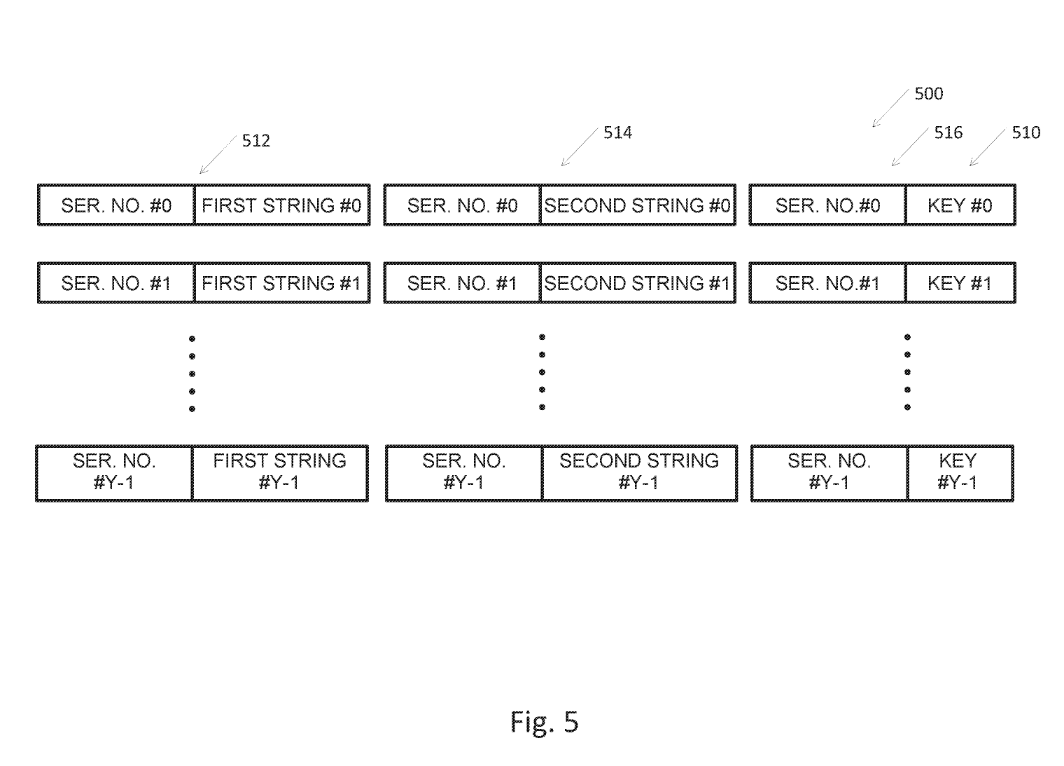

Reference is now made to FIG. 5 depicting a preimage of a modified Merkel puzzle 500, according to embodiments of the invention. Modified Merkel puzzle 500 may include a plurality of rows 510. Each row 510 may include a plurality of cryptographically hashed messages, e.g., three. The preimages (e.g., the numbers or strings that were hashed) of the cryptographically hashed messages may include for example a row serial number and a string. In the Example presented in FIG. 5, row #0 may include a first preimage 512, a second preimage 514 and a third preimage 516. Each of the preimages 512, 514 and 516, may include a row serial number and a random string. In some embodiments, the row serial number may be ordered, e.g., sequential. According to some embodiments, an identifier may be generated by performing an operation on a subset of the strings (the subset may include one, some, or all of the strings). For example, the identifier may be generated by performing bitwise XOR on the first string and the second string in a row, e.g., the identifier of row #0 may be generated by performing bitwise XOR on first string #0 and second string #0. Other operations on other subsets may be used. Modified Merkel puzzle 500 may be generated so that each identifier is unique or substantially unique, for a single row. According to some embodiments, a symmetric key may be generated by performing an operation on a subset of the strings (the subset may include one, some, or all of the strings). For example, the symmetric key may be equal to the third string. In some embodiments, the symmetric key may be generated by performing bitwise XOR on some of the bits of one string and some bits of another string, or xored with a result of hash function over the concatenated two strings, to obtain a value that is computationally independent from and computationally uncorrelated with the identifier. When the symmetric key is independent from and uncorrelated with the identifier, a listener (e.g. an entity reading or obtaining the communications such as malicious entity 140) may obtain no information concerning the chosen row and the chosen symmetric key, while previously used schemes used and revealed some bits of the solution as the identifier while other portions of the same solution were used as the symmetric key, thus reducing the scope of the exhaustive search of the listener.

The plurality of cryptographically hashed messages in each row may include a row serial number that may be consecutive across rows. The row serial number may cause the computation of a certain row to be uncorrelated with the computation of other rows. For example, when guessing the preimage of a hashed value in one of the cryptographically hashed messages, the guess starts with the chosen row, and when the hash function is applied to guessed preimages the result will not fit puzzles from other rows that have preimages with a different row number.

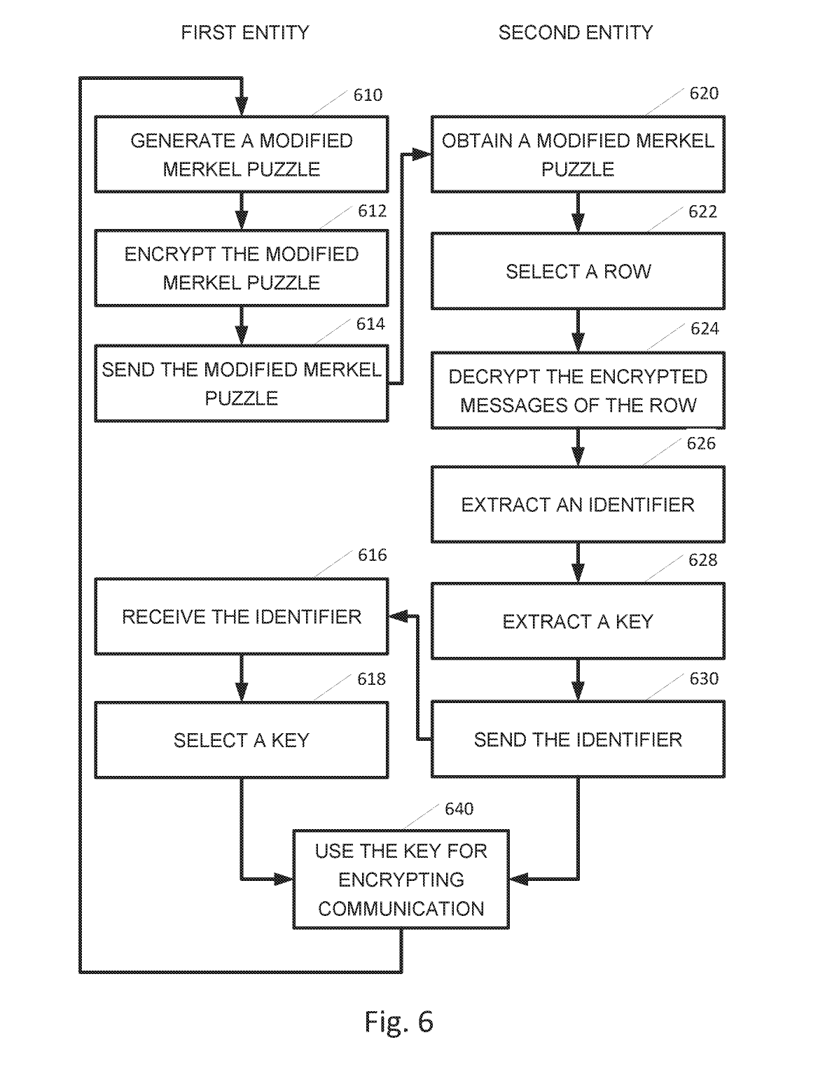

Reference is now made to FIG. 6 which is a flowchart of a method for establishing a symmetric key between two entities, according to embodiments of the invention. According to embodiments of the invention, the method for generating a common secret between two entities may be performed, for example, by two entities such as first entity 110 and second entity 120 depicted in FIG. 1.

In operation 610 a modified Merkel puzzle 500 may be generated, e.g., by first entity 110. For example, modified Merkel puzzle 500 including a plurality of cryptographically hashed messages as disclosed herein and depicted in FIG. 5 may be generated. In operation 612, the modified Merkel puzzle 500 may be encrypted using a known symmetric key. According to some embodiments a plurality of iterations of generating symmetric keys may be performed, each time generating a new modified Merkel puzzle 500 and using a symmetric key from a previous iteration to encrypt the modified. Merkel puzzle 500 of the current iteration. In some embodiments, the row serial numbers of a current iteration are continuous to these of the previous iteration. A known or otherwise agreed upon symmetric key, possibly an all zeros key, may be used for the first iteration. In operation 614 the encrypted modified Merkel puzzle 500 may be sent to a second entity, e.g., second entity 120. In some embodiments, the encrypted modified Merkel puzzle may be hashed prior to sending and signing the hash of the encrypted modified Merkel puzzle. The signature may be sent to the second entity together with the hash of the encrypted modified Merkel puzzle as a proof of the identity of the first entity. The encrypted modified Merkel puzzle may be signed using Lamport signature of a nested tree, as disclosed herein.

In operation 620 modified Merkel puzzle 500 may be obtained by second entity 120. In operation 622, a row out of the plurality' of rows of modified Merkel puzzle 500 may be selected by second entity 120. In operation 624 the encrypted messages of the selected row may be decrypted by second entity 120. For example, second entity 120 may use brute force analysis to decrypt the encrypted messages of the selected row. As disclosed herein, each message may include a row serial number and a string. In operation 626, second entity 626 may extract the identifier of the selected row. For example, the identifier may be extracted or generated by performing an operation on a subset of the strings of the selected row. For example, the identifier of a row may be generated by performing bit wise XOR on a first string and a second string. Other operations and other strings of the row may be used for extracting the identifier. In operation 628 second entity 120 may extract the symmetric key. For example, the symmetric key may equal one of the strings or may be generated by performing an operation on a subset of the strings of the selected row. In operation 630, second entity 120 may send the identifier to first entity 110. In operation 616 first entity 110 may receive or obtain the identifier. In operation 618 first entity may select a symmetric key based on the identifier. First entity 110 may be aware of how second entity 120 extracts the identifier and the symmetric key and may repeat the same operations when generating identifiers and symmetric keys. First entity 110 may select the same row as second entity 110 according to received identifier. For example, first entity 110 may generate identifiers for some or all the rows in the modified Merkel puzzle 500, and find the row with the same identifier as the received identifier. First entity 110 may extract the symmetric key from the selected row, e.g., by performing an operation on a subset of strings of the selected row, e.g., the same operation that was performed by second entity in operation 628. In operation 640 first entity and second entity may use the common symmetric key, e.g., for encrypting communication between them.

Messages can be hashed and the hash can be signed e.g., using Lamport signatures, and nested trees as disclosed herein, to withstand man-in-the-middle attacks, thus obtaining hash based, quantum safe key establishment. Combined with blockchain based certificate authority, and possibly secret sharing based key establishment and communication, a quantum safe public key infrastructure may be obtained.

According to some embodiments of the present invention, information, such as messages, signatures, roots, encrypted modified Merkel puzzle and any other data may be sent using secret sharing. In some embodiments, information may be sent using secret sharing over a plurality of channels, in some embodiments the channel may record the sent secret share for the sake of a communication proof. Some embodiments may include inductive multi-route authentication and common secret establishment using parties or devices that already (possibly incrementally) established trust (possibly via inductive multi-route authentication and common secret establishment) with a new device by using secret sharing. For example, sending messages and signatures and all other information between entities, establishing trust, and identifying an entity or authenticating an entity by a certificate authority (e.g., as in operation 310 in FIG. 3A) may be performed as described in application No. PCT/IL2017/050255 assigned to the applicant of the present application, which is incorporated in its entirety herein by reference.

Reference is made to FIG. 7, showing a high-level block diagram of a system or computing device according to some embodiments of the present invention. Computing device 700 may include a processor 705 that may be, for example, a central processing unit processor (CPU), a chip or any suitable computing or computational device, an operating system 715, a memory 720 that may include executable code 725, private keys 726 (e.g., private values 204, 214 and 224), public keys 727 (e.g., leaves 210, 211 and 221, roots 202, 212 and 224 and numbers, Vₖ) and nested trees 728 (e.g., nested trees 200, 210 and 220). Memory 720 may also include modified Merkel puzzles 500. As shown, computing device 70(1 may include or be operatively connected to storage system 730, input devices 760 and output devices 770. As shown, storage system 730 may include configuration data 733.

Private keys 726 may be stored in hardwired token, or as we suggest here in a SIM of a mobile phone, or a enclaved/protected memory of the mobile phone, or in a Near Field Communication (NFC)/Bluetooth/Radio-frequency identification (RFID) device that communicates the signature to the mobile device. A registration administrative process, similar to the one used for handling hardware token can be used to respect the legal and court requirements.

According to some embodiments, private keys 726 may include all private key of all the nested trees that were not already used. According to some embodiments, private keys 726 may include only a single value or two values from which all private keys 726, public keys 727 and nested trees 728 may be generated as disclosed herein (thus, public keys 727 and nested trees 728 may not be continuously stored).

Processor 705 (or one or more controllers or processors, possibly across multiple units or devices) may be configured to carry out methods described herein, and/or to execute or act as the various modules, units, etc. More than one computing device 700 may be included in, and one or more computing devices 700 may be, or act as the components of, a system according to some embodiments of the invention. Processor 705 may be or may include a microprocessor, a microcontroller, a digital signal processor (DSP), a field programmable gate array (FPGA), an integrated circuit (IC), an application specific integrated circuit (ASIC), a programmable logic device (PLD), a state machine, gated logic, discrete hardware components, dedicated hardware finite state machines, or any other suitable hardware.

Operating system 715 truly be or may include any code segment (e.g., one similar to executable code 725 described herein) designed and/or configured to perform tasks involving coordination, scheduling, arbitration, supervising, controlling or otherwise managing operation of computing device 700, for example, scheduling execution of software programs or enabling software programs or other modules or units to communicate. Operating system 715 may be a commercial operating system, e.g., Windows, Linux, Android and the like.

Memory 720 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 720 may be or may include a plurality of, possibly different memory units. Memory 720 may be a computer or processor non-transitory readable medium, or a computer non-transitory storage medium, e.g., a RAM.

Randomly generating a value or number as referred to herein may be, or may include, generating a value or number that cannot be reasonably predicted, e.g., as done for lottery games or by a random-number generator (RNG) as known in the art.

Executable code 725 may be any executable code, e.g., an application, a program, a process, task or script. Executable code 725 may be executed by processor 705 possibly under control of operating system 715. For example, executable code 725 may be an application that secures a communication channel and/or authenticates a remote device as further described herein. Embedded in memory 720, executable code 725 may be firmware as known in the art.

Although, for the sake of clarity, a single item of executable code 725 is shown in FIG. 6, a system according to some embodiments of the invention may include a plurality of executable code segments similar to executable code 725 that may be loaded into memory 720 and cause processor 705 to carry out methods described herein. For example, units or modules described herein (e.g., signing entity 110, verifying entity 120 and certificate authority 130 described herein) may be, or may include, processor 705, memory 720 and executable code 725.

For example, the components shown in FIG. 1, e.g., signing entity 110, verifying entity 120 and certificate authority 130, as further described herein may be, or may include components of, computing device 700, e.g., include a processor 705, a memory 720 and executable code 725. For example, by executing executable code 725 stored in memory 720, processor 705, e.g., when included in a security enforcement unit as described, may be configured to carry out a method of signing messages by for example, executing software or code stored in memory 720. For example, included in a security enforcement unit in a first device, processor 705 may be configured to use a plurality of trees for signing messages, use root-nested trees for signing messages or to establish a symmetric key between two entities, etc., as disclosed herein.

Storage system 730 may be or may include, for example, a hard disk drive, a Compact Disk (CD) drive, a CD-Recordable (CD-R) drive, a universal serial bus (USB) device or other suitable removable and/or fixed storage unit. Content may be stored in storage system 730 and may be loaded from storage system 730 into memory 720 where it may be processed by processor 705. In sonic embodiments, some of the components shown in FIG. 6 may be omitted. For example, included in a network hub, a smartphone, cellular phone, or in a wearable device, memory 720 may be a non-volatile memory or a non-transitory storage medium having the storage capacity of storage system 730. Accordingly, although shown as a separate component, storage system 730 may be embedded or included in memory 720.

Input devices 760 may be or may include a mouse, a keyboard, a touch screen or pad or any suitable input device. It will be recognized that any suitable number of input devices may be operatively connected to computing device 700 as shown by block 760. Output devices 770 may include one or more displays or monitors, speakers and/or any other suitable output devices. It will be recognized that any suitable number of output devices may be operatively connected to computing device 700 as shown by block 770. Any applicable input/output (I/O) devices may be connected to computing device 700 as shown by blocks 760 and 770. For example, any one or more of a wired or wireless network interface card (NIC); a WiFi or Bluetooth component or chip; a universal serial bus (USB) device; or an external hard drive may be included in, or connected to computing device 700 by, input devices 760 and/or output devices 770.

A system according to some embodiments of the invention may include components such as, but not limited to, a plurality of central processing units (CPU) or any other suitable multi-purpose or specific processors or controllers (e.g., processors similar to processor 710), a plurality of input units, a plurality of output units, a plurality of memory units, and a plurality of storage units. A system may additionally include other suitable hardware components and/or software components. In some embodiments, a system may include or may be, for example, a personal or laptop computer, a server computer, a network device, a smartphone, smartwatch or other mobile device, an Internet of things (IoT) device or object, or any other suitable computing device. An IoT device may include any component or system enabling the IoT device to communicate over a network (e.g., over the internet or over a WiFi or Bluetooth network). For example, an IoT device may be designed or adapted to communicate with remote devices using the internet protocol (IP). Accordingly, a system as described herein may include any number of devices such as computing device 700.

In the description and claims of the present application, each of the verbs, “comprise” “include” and “have”, and conjugates thereof, are used to indicate that the object or objects of the verb are not necessarily a complete listing of components, elements or parts of the subject or subjects of the verb. Unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of an embodiment as described. In addition, the word “or” is considered to be the inclusive “or” rather than the exclusive or, and indicates at least one of, or any combination of items it conjoins.

Descriptions of embodiments of the invention in the present application are provided by way of example and are not intended to limit the scope of the invention. The described embodiments comprise different features, not all of which are required in all embodiments. Some embodiments utilize only some of the features or possible combinations of the features. Variations of embodiments of the invention that are described, and embodiments comprising different combinations of features noted in the described embodiments, will occur to a person having ordinary skill in the art. The scope of the invention is limited only by the claims.

Unless explicitly stated, the method embodiments described herein are not constrained to a particular order in time or chronological sequence. Additionally, some of the described method elements may be skipped, or they may be repeated, during a sequence of operations of a method.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A computer-implemented method of signing a message by a first entity, the method comprising:
generating a plurality of leaves, wherein each leaf comprises public values corresponding to private values of a Lamport signature;
generating a plurality of trees each comprising a subgroup of the plurality of leaves;
using leaves of a currently used tree for signing messages sent to a second entity; and
if a last leaf of the currently used tree was used for signing, then using a leaf of a following tree for signing a message.

2. The method of claim 1, wherein the private values comprise a hash-based pseudo-random sequence.

3. The method of claim 2, comprising generating the hash-based pseudo-random sequence by hashing two values and performing an operation between hash results.

4. The method of claim 3, wherein the operation is bitwise XOR.

5. The method of claim 1, comprising:
if the last leaf of the currently used tree was used for signing, then publishing a root of a following tree.

6. The method of claim 1, comprising:
if the last leaf of the currently used tree was used for signing, then publishing a root of the following tree and an auxiliary value, the auxiliary value enabling the second entity to verify that the root of the following tree was generated by the first entity.

7. The method of claim 6, wherein the auxiliary value is generated so that hashing a concatenation of the root of the following tree and the auxiliary value provides the auxiliary value of the currently used tree.

8. The method of claim 1, wherein the trees are nested trees and wherein private values of a nested tree of level k are generated by hashing private values of a nested tree of level k−1 using a cryptographic hash function.

9. A computer-implemented method of establishing a symmetric key between two entities, the method comprising:
generating a modified Merkel puzzle, wherein the modified Merkel puzzle comprises a plurality of rows, each row comprising a plurality of hashed values, each preimage of a hashed value comprising a row serial number and a random string;
sending the hash based Merkel puzzle to a second entity;
receiving an identifier from the second entity, wherein the identifier is generated by the second entity by:
selecting a row;
finding the preimage of the messages of the selected row; and
extracting the identifier of the selected row from at least two preimages;
selecting a same row as the second entity according to the received identifier;
extracting a symmetric key from the selected row; and
using the symmetric key to encrypt communication with the second entity.

10. The method of claim 9, comprising:
performing a plurality of iterations of generating symmetric keys, wherein in each iteration new modified Merkel puzzles are generated.

11. The method of claim 10, comprising:
encoding the modified Merkel puzzles using a symmetric key from a previous iteration prior to sending.

12. The method of claim 9, wherein the symmetric key is extracted by performing an operation on a subset of strings of the selected row.

13. A system for signing a message between two entities, the system comprising:
a first entity comprising:
a memory; and
a processor configured to:
generate a plurality of leaves, wherein each leaf being a data structure comprising public values corresponding to private values of a Lamport signature;
generate a plurality of trees each comprising a subgroup of the plurality of leaves;
use leaves of a currently used tree for signing messages sent to a second entity; and
if a last leaf of the currently used nested tree was used for signing, then use a leaf of a following tree for signing a message.

14. The system of claim 13, wherein the private values comprise a hash-based pseudo-random sequence.

15. The system of claim 14, wherein the processor is configured to generate the hash-based pseudo-random sequence by hashing two values and performing an operation between hash results.

16. The system of claim 15, wherein the operation is bitwise XOR.

17. The system of claim 13, wherein the processor is configured to:
if the last leaf of the currently used tree was used for signing, then publish a root of the following tree and an auxiliary value, the auxiliary value enabling the second entity to verify that the root of the following tree was generated by the first entity.

18. The system of claim 17, wherein the processor is configured to generate the auxiliary value so that hashing a concatenation of the root of the following tree and the auxiliary value provides the auxiliary value of the currently used tree.

19. The system of claim 13, wherein the processor is configured to:
generate a modified Merkel puzzle, wherein the modified Merkel puzzle comprises a plurality of rows, each row comprising a plurality of hashed values, each preimage of a hashed value comprising a row serial number and a random string;
send the modified Merkel puzzle to a second entity;
receive an identifier from the second entity, wherein the identifier is generated by the second entity by:
selecting a row;
finding the preimage of the messages of the selected row; and
extracting the identifier of the selected row from at least two preimages;
select a same row as the second entity according to the received identifier;
extract a symmetric key from the selected row; and
use the symmetric key to encrypt communication with the second entity.

20. The system of claim 19, wherein the processor is configured to use a leaf of the currently used tree for signing the modified Merkel puzzle prior to sending.
